(19) United States
(12) Patent Application Publication
(10) Pub. No.: US 2007/0026101 A1
(43) Pub. Date: Feb. 1, 2007

(54) Slit mechanism of image recording apparatus

(75) Inventors: Haruhiko Arai, Kanagawa (JP); Noboru Kinomoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/496,550

(22) Filed: Aug. 1, 2006

(30) Foreign Application Priority Data
Aug. 1, 2005 (JP) 2005-222498

(51) Int. Cl. B28B 11/14

(52) U.S. Cl. 425/306

(57) ABSTRACT

The slit mechanism of an image recording apparatus includes slitter units, each including a pair of slitters, for slitting margins on a periphery of each of one or more images recorded on an image recording medium side by side along a width direction in a conveying direction by utilizing a conveying force of the recording medium, a guide unit for guiding a scrap that is cut off when the recording medium is slit by a slitter of the slitter unit and a slitter moving unit for moving the slitter and the guide unit in synchronization in the width direction of the recording medium between a slitting position at which the recording medium is slit into a predetermined width corresponding to the predetermined print size and a position outside the recording medium in the width direction. The guide unit is disposed only at a position where the scrap is cut off by slitting the margins of the recording medium with the slitter.

### BACKGROUND OF THE INVENTION

The present invention relates to a slit mechanism of an image recording apparatus which cuts off and removes a margin on a periphery of the image recorded on an image recording medium, and more particularly to a slit mechanism of an image recording apparatus which is capable of smoothly collecting marginal scraps separated when a recording medium on which an image is recorded is cut (hereinafter, “cut” refers to cutting an image recording medium in a direction orthogonal to a conveying direction) and slit (hereinafter, “slit” refers to cutting an image recording medium in the conveying direction).

Recently, with the use of an image recording medium obtained by forming a transparent protection layer made of a thermoplastic resin on the surface of a substrate, it has become possible to produce prints having glossiness almost equal to that of photographic prints (that is, prints like photographic prints) by the electrophotographic system, the thermal print system, or the like.

In the production of such prints, it has been desired to be able to produce prints with various sizes by one apparatus. Moreover, there is often a demand to produce so called borderless prints having no margin on the periphery of an image.

However, in the case of producing a borderless print (that is, a print with an image recorded on the entire surface) by the image recording apparatus utilizing the general electrophotographic system or thermal print system, an image is recorded on an image recording medium in a state where a margin is left on the image recording medium (recording sheet or image receiving sheet), and the margin needs to be cut off (by slitting and cutting the image recording medium) in the next process (for example, refer to JP 10-213944 A and JP 2001-63166 A).

The margin that was cut off in this case is unnecessary, so that it is preferable to separate and discharge the margin with guide means or guide member that is arranged immediately downstream a slit and a cutter in a conveying direction.

Considering a wide variety of sizes of the prints, it is not important that the apparatus is capable of always cutting the image recording medium into prints having a constant width. The important issue is that the apparatus is capable of making prints with sizes corresponding to a user's order.

Conventionally, a recording sheet or image receiving sheet with a predetermined size larger than various print sizes is used to form multiple images thereon at the same time with a layout corresponding to given print sizes, and thereafter the recording sheet with the multiple images recorded thereon is slit and cut for each image, thereby obtaining prints with the given print sizes.

As described above, in the case of using a recording sheet with the predetermined size larger than various print sizes to form multiple images on the recording sheet at the same time with a layout corresponding to the given print sizes, and thereafter slitting and cutting the recording sheet for each image, the image recording apparatus needs to be provided with multiple pairs of slitters for slitting edges on both sides of each image, and forward end cutter and rear end cutter for cutting forward and rear ends of each image (the forward cutter may double as the rear cutter).

As described above, in order to smoothly perform the slitting process, it is preferable that a margin separated from the recording sheet on which images are formed by slitting with a slitter be smoothly guided to a collection unit to be smoothly collected therein so as not to prevent subsequent margins that are cut off in the same way from entering the collection unit, or cause margins that were cut off to scatter in the image recording apparatus.

In this case, consideration should be given to the positional relation between the upper and lower blades of the slitter. That is, when an image is formed on the upper surface of the recording sheet or image receiving sheet, there are two cases considered regarding to the positional relation between an upper blade 200a and a lower blade 200b positioned at the edge of each side of a print P to be slit as shown in FIGS. 5A and 5B. One is that the lower blade 200b is positioned inside the upper blade 200a as shown in FIG. 5A (that is, the upper blade 200a is positioned outside), and the other one is that the upper blade 200a is positioned inside the lower blade 200b as shown in FIG. 5B (that is, the lower blade 200b is positioned outside).

In the case of cutting the recording sheet or image receiving sheet using a guillotine cutter, it is generally considered to be preferable to cut the recording sheet from the side on which an image is recorded (i.e., image recording surface). However, in the case of cutting the recording sheet using a slitter, the cutting direction of the recording sheet is less likely to be a problem, so that there are generally used two types of apparatus with different positional relations of blades as above.

Further, there is an image recording apparatus capable of forming an image on both sides of the recording sheet or image receiving sheet. In this case, there is no concept of which side of the recording sheet is the image recording surface (image receiving sheet), so that the positional relation between the upper and lower blades does not have a significant meaning.

Therefore, there is no particular limit to the positional relation between the upper and lower blades of the slitter (that is, which blade should be placed inside or outside). However, the point to be taken into consideration at this time is the configuration (shape) and the arranging position of the guide means for smoothly guiding a tip part of the margin (hereinafter referred to as “scrap Pₒ”) separated by cutting and slitting the recording sheet.

That is, as shown in FIGS. 6A and 6B, the bending direction of the scrap Pₒ differs depending upon the positional relation between the upper blade 200a and the lower blade 200b (that is, which blade is placed inside or outside). Therefore, depending upon the positional relation between the blades, a traveling direction and a traveling stability of the scrap Pₒ having been slit by the blades 200a and 200b differ, which would affect the stability in collecting the scraps.

As shown in FIG. 6A, in the case where the upper blade 200a of the slitter is positioned outside, the tip part of the scrap Pₒ is sent downward with respect to the conveying direction of the recording sheet (image receiving sheet) and travels downwardly with respect to the conveying direction according to gravity. Therefore, the scrap Pₒ naturally travels downwardly with respect to the conveying direction only by letting the scrap Pₒ travel toward the conveying direction of the recording sheet (image receiving sheet). Thus, even if the scrap Pₒ is not guided in a predetermined direction (e.g., the width direction of the recording sheet), the traveling direction of the scrap Pₒ is stabilized, thus enabling collection of the scrap Pₒ to be smoothly performed.

On the other hand, in the case where the upper blade 200a of the slitter is positioned inside, the lower blade 200b is positioned outside as shown in FIG. 6B, so that the tip part of the scrap Pₒ is sent upward in the conveying direction of the recording sheet and travels in a direction against gravity. Therefore, the scrap Pₒ traveling upward after being slit by the blades needs to be appropriately guided in both the width direction and a vertical direction for stabilizing the traveling direction of the scrap Pₒ and stably collecting the scrap Pₒ.

Further, in the case shown in FIG. 6B, the scrap Pₒ sent upward finally drops downward to be collected, so that there is a possibility that the scrap Pₒ contacts and damages the edge portion of the print P. Thus, it is not preferable to position the lower blade 200b outside as shown in FIG. 6B. SUMMARY OF THE INVENTION

The present invention has been achieved in view of the above problems, and an object of the present invention is to solve the problems of the conventional image recording apparatus and to provide a slit mechanism of the image recording apparatus which can be preferably used in the case where a recording sheet with a predetermined size larger than various print sizes is used to form multiple images thereon at the same time with a layout corresponding to print sizes, and thereafter the recording sheet with the multiple images recorded thereon is cut and slit for each image.

In order to achieve the above object, the present invention provides the slit mechanism of an image recording apparatus used to obtain a print of a predetermined print size by cutting off and removing margins on a periphery of each of one or more images that were recorded on an image recording medium side by side along a width direction, including:

slitter units for slitting the margins of the recording medium in a conveying direction of the recording medium in accordance with the predetermined print size by utilizing a conveying force of the recording medium, the slitter units each including a pair of slitters, being disposed upstream and/or downstream in the conveying direction of a cutter that cuts the margins of the recording medium in the width direction orthogonal to the conveying direction in accordance with the predetermined print size while conveying of the recording medium is stopped, and being arranged along the conveying direction of the recording medium;

guide means for guiding a scrap that is cut off when the recording medium is slit by at least one slitter of the pair of slitters; and

slitter moving means for moving the at least one slitter of the pair of slitters and the guide means in synchronization in the width direction of the recording medium between a slitting position at which the recording medium is slit into a predetermined width corresponding to the predetermined print size and a position outside the recording medium in the width direction,

wherein the guide means is disposed only at a position where the scrap is cut off by slitting the margins of the recording medium with the at least one slitter of the pair of slitters.

In accordance with the slit mechanism of the image recording apparatus according to the present invention, preferably, the pair of slitters includes two upper blades and two lower blades;

the lower blades are positioned inside the upper blades while being engaged with the upper blades from inside, respectively, and slit the recording medium; and

an upstream end of the guide means is arranged above at least one of the lower blades of the pair of slitters, and the guide means is disposed above the at least one of the lower blades from a position upstream of a slit starting position at which the recording medium is slit by the at least one slitter of the pair of slitters toward downstream side and is bent in a vicinity of a position at which the recording medium passes above the at least one of the lower blades so as to guide the scrap downward.

Further, in accordance with the slit mechanism of the image recording apparatus according to the present invention, preferably, the recording medium is slit by one of the slitter units located on a most downstream side in the conveying direction in a case where one image is recorded on the recording medium along the width direction.

Further, in accordance with the slit mechanism of the image recording apparatus according to the present invention, preferably, the recording medium is slit for one image by a first slitter unit of the slitter units, and is slit for a remaining image by a second slitter unit of the slitter units that is arranged downstream of the first slitter unit in the conveying direction, in a case where multiple images are recorded on the recording medium side by side along the width direction.

According to the present invention having the above configuration, it is possible to realize the slit mechanism of the image recording apparatus which can be preferably used in the case where a recording sheet with a predetermined size larger than various print sizes is used to form multiple images thereon at the same time with a layout corresponding to the print sizes, and thereafter the recording sheet with the multiple images recorded thereon is cut and slit for each image.

### BRIEF DESCRIPTION OF THE DRAWINGS

FIG. 1 is a conceptual diagram of an image recording apparatus including a slit mechanism according to one embodiment of the present invention;

FIGS. 2A and 2B are conceptual diagrams of examples of image recording by the image recording apparatus shown in FIG. 1;

FIG. 3 is a side view showing a main structure of the slit mechanism according to one embodiment;

FIGS. 4A to 4C are top views showing examples of positions of guide members of the slit mechanism;

FIGS. 5A and 5B are schematic side views for explaining the arrangement of an upper blade and a lower blade of a slit mechanism;

FIG. 6A is a view explaining the traveling direction of a scrap in the case of the blade arrangement shown in FIG. 5A;

FIG. 6B is a view explaining the traveling direction of a scrap in the case of the blade arrangement shown in FIG. 5B;

FIGS. 7A and 7B are views explaining the angles of the blades; and

FIG. 8 is a view explaining the way to decide the angle of the blade.

### DESCRIPTION OF THE PREFERRED EMBODIMENTS

Hereinafter, an explanation is made in detail of a slit mechanism of an image recording apparatus according to the present invention (hereinafter simply referred to as “slit mechanism”) in accordance with preferred embodiments shown in the attached drawings.

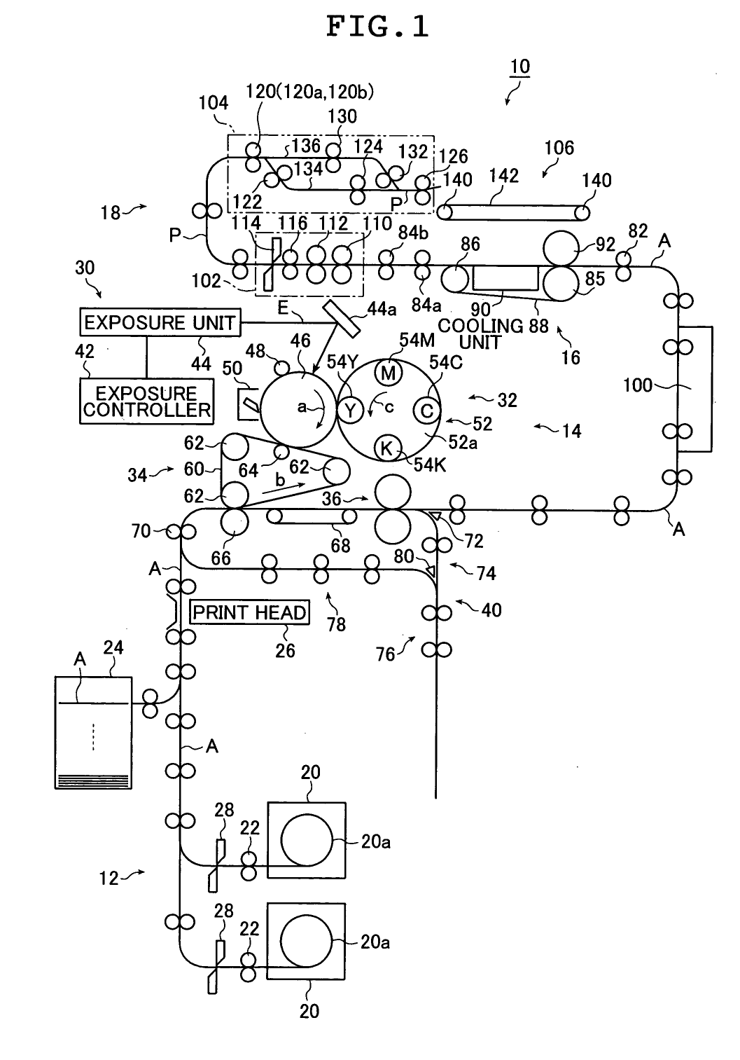

FIG. 1 shows a conceptual diagram of an image recording apparatus including a slit mechanism according to one embodiment of the present invention.

An image recording apparatus 10 shown in FIG. 1 records an image on a recording sheet (or image receiving sheet) A by the electrophotographic system and produces a print, and basically includes a recording sheet supplying section 12, an image forming section 14, a surface treatment section 16, and a cutting/arranging section 18. The image recording apparatus 10 also includes a position adjusting section 100 provided between the image forming section 14 and the surface treatment section 16. Further, various components arranged in the known image recording apparatus such as means for conveying the recording sheet A (e.g., a conveying roller pair, and a guide member), a sensor for detecting the recording sheet A are also provided in each section or between the adjacent sections according to need, although they are not shown in the drawings and are not denoted by reference numerals.

The image recording apparatus 10 records an image corresponding to a print size on the recording sheet A, and thereafter cuts and slits the recording sheet A into the print size to produce a print (i.e., finished print). In the illustrated example, as a preferred aspect, the image recording apparatus 10 imposes multiple images (e.g., two images or four images) on one recording sheet A, i.e., performs so-called multi-image imposition, according to need, and thereafter cuts and slits the recording sheet A according to the print sizes of the images to produce multiple prints from one recording sheet A.

In the image recording apparatus 10, in order to prevent contamination of the apparatus due to unfixed toner or the like, it is preferable to form an image on the recording sheet A while leaving a margin on the periphery of the image (including the forward and rear ends of the recording sheet A in the conveying direction, and both the lateral ends of the recording sheet A in a direction orthogonal to the conveying direction). When the multi-image imposition is performed, a space may be or may not be left between adjacent images.

In the following description, for descriptive purposes, the direction orthogonal to the conveying direction of the recording sheet A is referred to as the “width direction”, and the size of the recording sheet A in the width direction is referred to as the “width”. Also, the size of the recording sheet A in the conveying direction is referred to as the “length”. Further, the forward and rear ends of the recording sheet A are determined with respect to the conveying direction.

The recording sheet supplying section 12 (hereinafter referred to as “supplying section 12”) is a section for supplying the cut recording sheet A to the image forming section 14.

In the image recording apparatus 10 in the illustrated example, the supplying section 12 includes two loading units in each of which a magazine 20 that accommodates a recording sheet roll 20a obtained by winding a long recording sheet is loaded, and a loading unit of a cassette 24 that accommodates the cut recording sheet A.

The loading units for the magazines 20 usually accommodate the recording sheet rolls 20a whose widths or sizes are different from each other. The cassette 24 is a case as used in various printers, which is loaded into the image recording apparatus 10 after accommodating the recording sheet A.

The recording sheet A is not specifically limited, and any of various recording sheets or image receiving sheets used in an electrophotographic image recording apparatus can be used.

In the image recording apparatus 10 which utilizes the slit mechanism according to this embodiment, particularly, a recording sheet preferably used is that with which it is possible to produce a print having excellent glossiness and quality equal to that of a silver halide photographic print such as a recording sheet made by forming a transparent resin layer made of a thermoplastic resin on the surface of the substrate made of paper or the like (hereinafter referred to as a photo-like print sheet). With this recording sheet, it is possible to produce a print with excellent glossiness like the silver halide photographic print by the following method as an example. That is, a toner image is formed on the image forming surface of the recording sheet on which the transparent resin is formed, thereafter the image forming surface on which the toner image is formed is subjected to the heating and pressing treatment with a belt or the like having excellent surface smoothness to melt the transparent resin layer, and the melted transparent resin layer is cooled and solidified, whereby the surface properties of the belt or the like are transferred to the transparent resin layer (the toner may be fixed on the image forming surface in this treatment) (refer to JP 5-216322 A).

The thermoplastic resin that may be used for the transparent resin layer is not particularly limited, however, preferred examples thereof include polyester resin, polyethylene resin, and styrene-acrylic ester resin. The thickness of the transparent resin layer is also not specifically limited, however, in order to prevent strain under stress (bending strain) from causing breakage (cracking) after the surface treatment or the like, the thickness of 5 to 20 μm is preferable.

Although not illustrated in the drawings, each loading unit includes size detection means for detecting the size (i.e., width) of the recording sheet roll 20a accommodated in the magazine 20 and the size of the recording sheet A accommodated in the cassette 24 with a DIP switch, a barcode, or the like.

A drawing-roller pair 22 and a cutter 28 are disposed downstream of each magazine 20 loaded into one of the loading unit (i.e., downstream in the conveying direction of the recording sheet A).

The drawing-roller pair 22 is for drawing the recording sheet of the recording sheet roll 20a accommodated in the magazine 20. The cutter 28 is known cutting means such as a guillotine cutter for cutting a sheet-like material.

The drawing of the recording sheet from the recording sheet roll 20a by the drawing-roller pair 22 is stopped at the time when the recording sheet being fed on the downstream side from the cutter 28 has a predetermined length. Next, the cutter 28 is operated to cut the recording sheet into a predetermined size, and the thus cut recording sheet A is supplied to designated conveying means.

As described above, in the image recording apparatus 10 according to this embodiment, an image is formed on the recording sheet A so that a space (margin) is left on the periphery of the image. The cutting positions on the recording sheet A may be adjusted in accordance with the print size (image size) so that the resulting print is bordered at the forward and rear ends and/or the borders are adjusted in length.

The recording sheet A accommodated in the cassette 24 is drawn out by the known means utilized in various printers, and is supplied to the predetermined conveying means.

The recording sheet A which was drawn out of the magazine 20 and cut into the predetermined size by the cutter 28 and the recording sheet A drawn out of the cassette 24 are both conveyed to the image forming section 14 through conveying roller pairs.

There is disposed a printing head 26 for recording a back print onto a back surface of a print (that is, a surface onto which no recording of image is carried out) between two conveying roller pairs immediately upstream of the image forming section 14 in the conveying direction of the recording sheet A.

The printing head 26 is not specifically limited, and various known printing means such as an impact printer using an ink ribbon and an ink jet printer are usable.

The image forming section 14 is a section for forming a total image (including one image or plural images) onto the recording sheet A by electrophotography. The image forming section 14 includes an exposure subsection 30, a toner image forming subsection 32, a transferring subsection 34, a primary fixing roller pair 36, and a reversing subsection 40.

The exposure subsection 30 includes an exposure controller 42 and an exposure unit 44.

The exposure controller 42 obtains constituent images (or image data) to be reproduced on prints from the image supplying source, imposes the constituent images in accordance with the number of constituent images to be recorded (i.e., the number of images for imposition) on one recording sheet A after performing predetermined image processing, thereby defining a total image (including one image or plural images) to be recorded on one recording sheet A. In this application, one or more images to be recorded on the entire surface of one recording sheet A are collectively expressed as a total image, and the one or more images constituting the total image are each expressed simply as an image or a constituent image. However, in the case where there is no need to distinguish the constituent image from the total image, or the term used clearly means the constituent image or the total image, it is simply expressed as an “image”.

The exposure unit 44 is a known light beam scanning optical system including a light source of light beam (i.e., recording light) for exposing an electrophotographic photosensitive drum 46 of the toner image forming subsection 32 to be described later, a light deflection device, an fO lens, an optical path changing mirror, a light beam adjusting lens, and the like.

That is, the exposure unit 44 records a latent image onto the electrophotographic photosensitive drum 46 by emitting the light beam E modulated in accordance with the image data of the total image (namely, the total image to be recorded) supplied from the exposure controller 42 while deflecting the light beam E in the main scanning direction matched with the width direction (that is, the direction that is orthogonal to the conveying direction of the recording sheet A, i.e., orthogonal to the rotation direction of the electrophotographic photosensitive drum 46), and by making the emitted light beam E reflected by a mirror 44a to be incident on the electrophotographic photosensitive drum 46 at a predetermined exposure position.

The toner image forming subsection 32 is a known device for forming a toner image by electrophotography. The toner image forming subsection 32 includes the electrophotographic photosensitive drum 46 (hereinafter referred to as the photosensitive drum 46), charging means 48, cleaning means 50, and toner supplying means 52.

The photosensitive drum 46 is a known electrophotographic photosensitive drum, and is rotated in a direction of an arrow “a” shown in FIG. 1, with its central axis matched with the width direction. As described above, because the light beam E emitted from the exposure unit 44 is deflected in the width direction, the photosensitive drum 46 is two-dimensionally scanned by exposure to the light beam E modulated in accordance with the total image to be recorded.

The toner supplying means 52 includes four toner supplying units, namely, a C (cyan) toner supplying unit 54C, an M (magenta) toner supplying unit 54M, a Y (yellow) toner supplying unit 54Y, and a K (black) toner supplying unit 54K being attached to a rotatable drum-shaped member 52a at intervals of a 90° rotation angle.

The transferring subsection 34 includes a transfer belt 60 that is an endless belt a part of which contacts the photosensitive drum 46, three rollers 62 around which the transfer belt 60 is stretched, a press roller 64 for pressing the transfer belt 60 against the photosensitive drum 46 from the inside, a transfer roller 66, and a belt conveyor 68. The transfer belt 60 is rotated in a direction of an arrow “b” shown in FIG. 1 (that is, the same direction as the conveying direction of the recording sheet A) and acts as an intermediate transfer member of a toner image. In addition, the transfer roller 66 is movable between the position at which the transfer roller 66 nips the transfer belt 60 (or the recording sheet A) together with one of the rollers 62 and the position at which the transfer roller 66 is separated from the transfer belt 60.

While being rotated in the direction of the arrow “a” shown in FIG. 1, the photosensitive drum 46 is uniformly charged in the width direction by the charging means 48, and is two-dimensionally scanned by exposure to the light beam E modulated in accordance with the image data as above. Whereby, an electrostatic latent image is formed on the surface of the photosensitive drum 46. Next, the electrostatic latent image is developed by the toner supplying unit positioned at a developing position (i.e., at a position facing the photosensitive drum 46) of the toner supplying means 52, for example, by the Y toner supplying unit 54Y, and the Y toner image of is formed on the surface of the photosensitive drum 46.

The transfer belt 60 that partially contacts the photosensitive drum 46 and is pressed by the press roller 64 against the photosensitive drum 46 is rotated in the direction of the arrow “b” shown in FIG. 1 in synchronization with the rotation of the photosensitive drum 46. Therefore, the toner image of the photosensitive drum 46 that was developed by the toner supplying means 52 is transferred onto the transfer belt 60 at the contact part (that is, the part pressed by the pressure roller 64). The region of the photosensitive drum 46 whose toner image has been completely transferred onto the transfer belt 60 is cleaned by the cleaning means 50, so that the residual toner on the photosensitive drum 46 is removed therefrom.

In the illustrated embodiment, formation of the toner image and its transfer onto the transfer belt 60 are carried out in the above described manner by sequentially acting the four toner supplying units of the Y toner supplying unit 54Y, the M toner supplying unit 54M, the C toner supplying unit 54C, and the K toner supplying unit 54K.

For example, after the Y toner image has been transferred onto the transfer belt 60 as described above, the toner supplying means 52 (more specifically its main body 52a) is rotated in a direction of an arrow “c” shown in FIG. 1 by 90° so as to set the M toner supplying unit 54M to the developing position. After performing positioning to match an M toner image with the Y toner image on the transfer belt 60, a latent image is formed on the surface of the photosensitive drum 46, and the M toner image is formed on the surface of the photosensitive drum 46 to be transferred onto the transfer belt 60 in the same manner as described above. Thereafter, in the same way, a C toner image and a K toner image are transferred onto the transfer belt. Note that the transfer roller 66 is spaced apart from the transfer belt 60 during the above operation.

Accordingly, in the illustrated embodiment, each of the Y, M, C, and K toner images is formed on the surface of the transfer belt 60 after positioning. That is, a four-color (full-color) total image is formed.

On the other hand, the recording sheet A cut into a predetermined size is supplied from the supplying section 12 and is placed in a standby state at a predetermined position, for example, at a registration roller pair 70 immediately upstream of the transfer roller 66.

After the color total image has been formed on the transfer belt 60, the conveying of recording sheet A by the registration roller pair 70 is started in synchronization with the rotation of the transfer belt 60 so that the positions of the recording sheet A and the color total image formed on the transfer belt 60 are matched with each other. In addition, the transfer roller 66 is pressed against the transfer belt 60 (or the roller 62), so that the recording sheet A is conveyed while being nipped between the transfer belt 60 and the transfer roller 66. By conveying the recording sheet A while being nipped between the transfer belt 60 and the transfer roller 66 as above, the four-color toner image (total image) formed on the surface of the transfer belt 60 is transferred onto the recording sheet A, and the total image (including plural images) is formed on the surface of the recording sheet A.

As described above, the total image includes plural images imposed in accordance with the number of images to be recorded.

The recording sheet A on which the total image has been formed is conveyed on the belt conveyor 68 to the primary fixing roller pair 36.

The primary fixing roller pair 36 is a pair of conveying rollers, at least one of which is a heating roller. The primary fixing roller pair 36 may be capable of taking two states (that is, the state in which the recording sheet is nipped and the state in which the recording sheet is released) by moving the roller on the image forming surface side up and down or the like.

As in the case in which an image formed by common electrophotographic system is fixed, the primary fixing roller pair 36 conveys the recording sheet A on which the total image is formed by the transfer of the four-color toner image in the transferring subsection 34 while nipping it, whereby the total image composed of the four-color toner image is fixed onto recording sheet A by heating under pressure.

In the image recording apparatus 10 including the slit mechanism according to this embodiment, the image forming method is not limited to a method relying on the electrophotography as in the illustrated example, and any known image forming method is usable.

For example, the image forming methods implemented in various kinds of known printer (printing means) including a printer having a heat development step and uses a thermally developable photosensitive material as the image receiving medium on which an image is formed in the presence of an image forming solvent such as water; an ink jet printer; and a thermal printer using a thermal head are usable.

The reversing subsection 40 is a subsection for reversing the recording sheet A on which an image has been fixed by the primary fixing roller pair 36 so as to produce a so-called double-sided print.

In the illustrated example, the reversing subsection 40 includes first switching means 72 arranged downstream from the primary fixing roller pair 36, a branching path 74 branching from the conveying path at the downstream position of the primary fixing roller pair 36, a kickback unit 76 provided downstream from the branching path 74, a return conveying path 78 that branches from the branching path 74 and the kick back unit 76 to return to the registration roller pair 70 upstream from the transferring subsection 34, and second switching means 80 provided at the branch point of the kickback unit 76 and the return conveying path 78.

The first switching means 72 and the second switching means 80 are each known means for switching the conveying path for a sheet-like material such as a flapper that acts on (or is inserted into) the conveying path to thereby guide the recording sheet A to a predetermined conveying path.

When a double-sided print is produced in the image recording apparatus 10, the first switching means 72 acts on the conveying path on the downstream side from the primary fixing roller pair 36 to convey the recording sheet A with an image fixed by the primary fixing roller pair 36 to the kickback unit 76 through the branching path 74. Then, when the upstream end of the recording sheet A has reached the position on the downstream side from the second switching means 80, conveying of the recording sheet A is stopped.

Next, the second switching means 80 acts on the kickback unit 76 to change the conveying direction at the kickback unit 76 and the recording sheet A is conveyed in a direction opposite to the above direction, the second switching means 80 guides the recording sheet A to convey it to the registration roller pair 70 through the return conveying path 78, thereby reversing the recording sheet A.

The reversing subsection 40 may be provided by branching the conveying path at the downstream position of the later described surface treatment section 16 instead of branching it at the downstream position of the primary fixing roller pair 36 (primary fixing unit).

The recording sheet A having the image fixed by the primary fixing roller pair 36 is then subjected to position adjustment in the width direction at the position adjusting section 100 and subsequently conveyed to the surface treatment section 16.

As described above, in the image recording apparatus 10 according to this embodiment, one or more images are imposed on the recording sheet A (image imposition), and the recording sheet A is cut into individual images (prints) at a cutting subsection 102 according to the print sizes, thereby producing prints to be outputted as products.

The position adjusting section 100 is for adjusting a position of the recording sheet A in the width direction to a predetermined position according to the information about the width of the recording sheet A, the image forming position, and the like, so that the recording sheet A can be properly cut.

There is no limit to the means for adjusting the position of the recording sheet A in the width direction in the position adjusting section 100, and various known position adjusting means for a sheet-like material can be used.

Examples of the position adjusting means include means that applies a method which uses a guide plate that contacts the side end of the recording sheet A to regulate the position of the recording sheet A in the width direction, and a method in which a conveying roller pair having a position adjusting function in the axis direction is used to move the recording sheet A in the width direction while nipping it.

The surface treatment section 16 is arranged downstream from the position adjusting section 100.

A conveying roller pair 82 including a drive roller and a driven roller is disposed immediately upstream from the surface treatment section 16. The drive roller of the conveying roller pair 82 is connected to a drive source via a one-way clutch capable of idling only in the conveying direction. The conveying speed of the recording sheet A by the conveying roller pair 82 is set equal to or lower than that at the surface treatment section 16.

This point will be described later.

The surface treatment section 16 performs the surface treatment on the recording sheet A (and optionally secondary fixation of the toner image) when the above mentioned photo-like print sheet is used for the recording sheet A to produce a high-quality print having glossiness and the like equal to that of a silver halide photograph. To be more specific, the surface treatment section 16 performs the surface treatment as follows: The surface of the recording sheet A (i.e., image forming surface) is abutted and pressed against the belt-shaped surface treatment means to be heated, and thereafter is cooled.

Usually, print production using plain paper does not require the surface treatment and the fixing treatment in the surface treatment section 16, so the surface treatment section 16 let the recording sheet A pass therethrough without performing any treatment. Alternatively, no cutting operation is required in the subsequent cutting/arranging section 18, the recording sheet A may be outputted onto a given tray as a print immediately after the completion of toner image fixing with the primary fixing roller pair 36.

However, if necessary, the surface treatment described below may be carried out not only on the photo-like print sheet but also on various other recording sheets A such as plain paper.

In the illustrated example, the surface treatment section 16 includes a heating roller 85, a roller 86, a surface treatment belt 88 that is an endless belt stretched around the heating roller 85 and the roller 86, a cooling unit 90, and a nip roller 92.

The surface treatment belt 88 is a belt that serves as the surface treatment means, the surface (outer surface) of which has extremely high smoothness. The heating roller 85 is a known heating roller that generates heat to the temperature appropriate for the heating treatment of the recording sheet A. The cooling unit 90 contacts the inner surface of the surface treatment belt 88 to cool the surface treatment belt 88, thereby cooling the recording sheet A conveyed on the surface treatment belt 88. Further, the nip roller 92 is abutted and pressed against the surface treatment belt 88 at the position corresponding to the heating roller 85, whereby the recording sheet A is pressed against the surface treatment belt 88 and is conveyed on the surface treatment belt 88 while being nipped between the roller 92 and the belt 88.

Note that there is no limit to the heating means in the heating roller 85 and the cooling means in the cooling unit 90, and any known means are applicable.

As is apparent from FIG. 1, the recording sheet A having an image fixed thereon is conveyed to the surface treatment section 16 with its image forming surface directed to the surface treatment belt 88 side.

In the surface treatment section 16, first, the recording sheet A is conveyed while being nipped between the surface treatment belt 88 (or heating roller 85) and the nip roller 92, so that the surface of the recording sheet A (i.e., the surface of the transparent resin layer of the photo-like print sheet) is abutted and pressed against the surface of the surface treatment belt 88, and is heated by the heating roller 85.

As a result of the heating and pressing, the transparent resin layer of the recording sheet A is melted, so that the recording sheet A is conveyed by the surface treatment belt 88 in a state of loosely sticking to the surface treatment belt 88. While the recording sheet A is conveyed by the surface treatment belt 88 in the surface treatment section 16, the recording sheet A is cooled by the cooling unit 90, so that the melted transparent resin layer is solidified.

The thus cooled recording sheet A is separated from the surface treatment belt 88 at the roller 86 that is located the exit side of the surface treatment section 16 (i.e., at the portion at which the surface treatment belt 88 turns around the roller 86), and is supplied to the conveying roller pair 84a on the downstream side.

The transparent resin layer (thermoplastic resin) on the surface of the recording sheet A is pressed against the surface treatment belt 88 to be heated and melted, and thereafter is cooled and solidified in the above manner. Whereby, the surface properties of the surface treatment belt 88 are transferred onto the recording sheet A. As above, the surface treatment belt 88 has extremely high surface smoothness, so that the recording sheet A to which the surface properties of the surface treatment belt 88 have been transferred comes to have high surface smoothness and favorable glossiness, with the result that a print having a quality almost equal to that of a silver halide photographic print can be obtained.

In the surface treatment of the recording sheet A, by changing the surface properties of the surface treatment belt 88, it is possible to perform not only the treatment for applying glossiness as above but also various other treatments such as a matting (graining).

In the image recording apparatus 10 in the illustrated example, the heating condition and/or the cooling condition in the surface treatment section 16 may be adjustable, so that the glossiness and the like to be applied to the surface of the recording sheet A (print) can be adjusted.

Further, in the illustrated example, the recording sheet A is separated from the surface treatment belt 88 utilizing so called “stiffness” of the recording sheet A. Thus, preferably, as shown in FIG. 1, the roller 86 stretching the surface treatment belt 88 at the position where the recording sheet A is discharged from the surface treatment section 16 has a smaller diameter. Whereby, it is possible to improve the separation properties of the recording sheet A from the surface treatment belt 88.

The recording sheet A subjected to the surface treatment in the surface treatment section 16 is conveyed to the cutting subsection 102 of the cutting/arranging section 18 by the two conveying roller pairs 84 (84a and 84b).

The conveying roller pairs 84 each include a drive roller and a driven roller. The two conveying roller pairs 84 function as conveying means and load reducing means for conveying the recording sheet A subjected to the surface treatment from the surface treatment section 16 to the cutting subsection 102 of the next process. The drive roller of each conveying roller pair 84 is connected to a drive source via a one-way clutch capable of idling only in the conveying direction. In the illustrated example, as a preferred aspect, the conveying speed of the recording sheet A at each conveying roller pair 84 is set equal to or lower than that at the surface treatment section 16 (the surface treatment belt 88).

In the illustrated example, there are two conveying roller pairs 84 arranged between the surface treatment section 16 and the cutting subsection 102, however, the present invention is not limited thereto. As long as it is possible to convey the recording sheet A of any size, only one conveying roller pair 84 may be arranged between the surface treatment section 16 and the cutting subsection 102. Alternatively, three or more conveying roller pairs 84 may be arranged if needed.

In the case of arranging multiple conveying roller pairs 84 between the surface treatment section 16 and the cutting subsection 102, a drive source may be provided for each conveying roller pair, or some of or all the multiple conveying roller pairs 84 may be driven by one drive source.

Although described later in detail, in the cutting subsection 102, first and second slitter units 110 and 112 first slit the recording sheet A in the conveying direction (y direction) so as to have the width corresponding to the print size. Thereafter, the guillotine cutter 114 cuts the recording sheet A in the width direction (x direction). Whereby, prints corresponding to respective print sizes can be produced.

The first slitter unit 110 is a known slitter which utilizes a rotary cutter or the like, and slits the recording sheet A which is being conveyed. When the recording sheet A being conveyed is slit by the first slitter unit 110, a conveying load change occurs to the recording sheet A in the cutting subsection 102 in the direction in which the recording sheet A is returned to the upstream side (i.e., the direction in which the recording sheet A is pushed into the surface treatment section 16). Specially, the photo-like print sheet is often relatively thick in view of the quality required, so that this load change is large in comparison with that in the case of using plain paper or the like.

As described above, in the surface treatment section 16, the recording sheet A is conveyed by the surface treatment belt 88 in a state where the image forming side thereof loosely sticks to the surface treatment belt 88.

Thus, in the case where the conveying load change occurs to the recording sheet A in the cutting subsection 102, and the conveying load change that has occurred is transmitted to the surface treatment section 16 (or the recording sheet A in surface treatment section 16) while the recording sheet A is being conveyed in the cutting subsection 12 and on the surface treatment belt 88, the image forming surface (i.e., the surface on which the transparent resin layer is formed) of the recording sheet A slides on the surface treatment belt 88. Consequently, the surface of the recording sheet A cannot become smooth enough, thus failing to obtain required glossiness. Moreover, in the case where foreign matter such as dirt or dust enters between the surface treatment belt 88 and the recording sheet A, it would damage the surface treatment belt 88 when the recording sheet A slides on the surface treatment belt 88. The damaged portion of the surface treatment belt 88 is transferred to the image recording medium to be subsequently subjected to the surface treatment, thereby reducing the glossiness of the print produced from the image recording medium.

However, in the illustrated example, the conveying roller pairs 84 are used as the conveying means for conveying the recording sheet A from the surface treatment section 16 to the cutting subsection 102. The conveying roller pairs 84 convey the recording sheet A at the conveying speed equal to or lower than that at the surface treatment section 16, and each include a one-way clutch capable of idling only in the conveying direction.

Thus, even when the conveying load change (hereinafter, simply referred to as “load change”) occurs in the direction in which the recording sheet A is returned to the upstream side (i.e., the direction in which the recording sheet A is pushed into the surface treatment section 16) due to the slitting of the recording sheet A by the first slitter unit 110 and/or the second slitter unit 112 of the cutting subsection 102, the conveying roller pairs 84 each including the one-way clutch suppress the force that returns the recording sheet A upstream, thereby preventing this load change from being transmitted to the surface treatment section 16.

Further, the conveying speed of the recording sheet A by each conveying roller pair 84 is equal to or lower than that at the surface treatment section 16. Thus, the conveying roller pairs 84 do not cause the load change in the direction in which the recording sheet A is pulled out of the surface treatment section 16 (or the surface treatment belt 88).

Contrary to this, in the configuration of the illustrated example, there is a possibility that the surface treatment section 16 pushes the recording sheet A toward the conveying roller pairs 84, that is, the conveying roller pairs 84 cause the load change to occur in the direction in which the recording sheet A is pushed into the surface treatment section 16.

However, each conveying roller pair 84 includes the one-way clutch capable of idling in the conveying direction, so that when the recording sheet A is pushed into the conveying roller pairs 84 from the surface treatment section 16, the conveying roller pairs 84 idle in the conveying direction and do not cause the load change to occur. That is, in the illustrated example, the surface treatment section 16 controls the conveying of the recording sheet A so as to push the recording sheet A into the conveying roller pairs 84, so that the conveying load change does not occur to the recording sheet A in the surface treatment section 16.

At this time, the conveying speed of the recording sheet A by the conveying roller pairs 84a and 84b is preferably in a range of about 99% to 100% of that at the surface treatment section 16, and more preferably in a range of about 99.7% to 100% of that at the surface treatment section 16.

With the above construction, in the surface treatment section 16 (surface treatment device) in which an image recording medium such as the recording sheet A including the transparent resin layer is subjected to the surface treatment by bringing the image recording medium into contact with the surface treatment belt 88 and pressing it, and optionally heating the image recording medium, even if there is a factor such as the slitting process with the slitter which would cause the conveying load change to the recording sheet A in the surface treatment section 16, this load change is not transmitted to the surface treatment section 16, enabling the appropriate surface treatment to be stably performed. Accordingly, in producing prints by performing the surface treatment to impart glossiness, it is possible to stably perform appropriate surface treatment, so that prints having desired glossiness and the like can be stably obtained.

By arranging such load reducing means, the conveying load change which the cutting subsection 102 gives to the recording sheet A is not transmitted to that in the surface treatment section 16. Thus, there is no need to arrange the surface treatment section 16 and the first slitter unit 110 so that the distance therebetween is set longer than the maximum length of the recording sheet A to be used, and it is possible to arrange the surface treatment section 16 and the cutting subsection 102 (or the first slitter unit 110) to be close to each other, thereby making the image recording apparatus 10 small.

For stably obtaining prints with a predetermined image quality, it is not preferable to stop the conveying of the recording sheet A while performing the surface treatment in the surface treatment section 16. However, in the case of cutting the recording sheet A with the later described guillotine cutter 114 in the cutting subsection 102, the conveying of the recording sheet A is necessarily stopped. Thus, when the recording sheet A is cut with the guillotine cutter 114, the recording sheet A is required to be completely discharged from the surface treatment section 16. Therefore, the conveying distance of the recording sheet A from the surface treatment section 16 to the guillotine cutter 114 should be not less than the maximum length of the recording sheet A to be used.

In the image recording apparatus 10 in this embodiment, even if the load reducing means is provided for each conveying roller pair 84 that is the conveying means arranged downstream from the surface treatment section 16, the conveying load change (entry load change) may occur to the recording sheet A in the surface treatment section 16 when the recording sheet A is conveyed to the conveying roller pair 84 and the tip of the recording sheet A is nipped by the conveying roller pair 84. To solve this inconvenience, in the image recording apparatus 10, each conveying roller pair 84 preferably includes entry load reducing means.

Examples of the entry load reducing means include means that applies a method in which the nipping force (pressing force) in the conveying roller pair 84 is made smaller than that in a normal conveying roller pair. The conveying roller pairs 84 are only for conveying the recording sheet A, and the recording sheet A is in a state of being pushed from the surface treatment section 16 on the upstream side. Thus, the nipping force in each conveying roller pair 84 can be made small in comparison with that in a normal conveying roller pair, thereby making it possible to reduce the entry load of the recording sheet A on the conveying roller pair 84.

Alternatively, the following method is also preferably applied for reducing the entry load of the recording sheet A. That is, the conveying roller pair 84 is constructed so that a space is provided between the rollers so as not to contact with each other, and the space is adjusted to be slightly smaller than the thickness of the recording sheet A to be used.

Another method also preferably applied for reducing the entry load of the recording sheet A is as follows. That is, the rollers of the conveying roller pair 84 are first spaced apart by, for example, lifting the upper roller, and the recording sheet A is nipped by the conveying roller pair 84 after the tip part of the recording sheet A has passed the conveying roller pair 84. In this case, it is preferably to nip the recording sheet A after the passage of the tip part of the recording sheet A by gradually lowering the upper roller.

Still another method also preferably applied for reducing the entry load of the recording sheet A is as follows. That is, the nipping force in the conveying roller pair 84 is first set small, and is increased after the passage of the tip part of the recording sheet A therethrough.

In the image recording apparatus 10 according to this embodiment, one of the above four entry load reducing means may be used, or two or more of the above four entry load reducing means may be appropriately used in combination. Further, other entry load reducing means may be used in combination with one or more of the above four entry load reducing means.

In the illustrated example, as a preferable aspect, each of the two conveying roller pairs 84a and 84b includes the one-way clutch. However, the present invention is not limited thereto, and one of the conveying roller pairs 84a and 84b may include the one-way clutch capable of idling in the conveying direction.

As the illustrated example, preferably, the load reducing means (more preferably, a conveying roller pair including the one-way clutch capable of idling only in the conveying direction as the illustrated example) is provided at least immediately downstream from the surface treatment section 16, and the conveying speed of the recording sheet A conveyed by the conveying means from the surface treatment section 16 to the cutting subsection 102 is set equal to or lower than that at the surface treatment section 16.

In the conveying means from the surface treatment section 16 to the cutting subsection 12 such as the conveying roller pair 84, the load reducing means is not limited to the conveying roller pair using the one-way clutch as in the illustrated example.

Examples of the load reducing means include a conveying roller pair using a torque limiter. Alternatively, conveying means such as a belt conveyer for conveying the recording sheet A placed thereon may be also used.

In the image recording apparatus 10 in the illustrated example, as a preferred aspect, the conveying roller pair 82 disposed immediately upstream from the surface treatment section 16 is such that the drive roller thereof is connected to a drive source via the one-way clutch capable of idling in the conveying direction, and the conveying speed of the recording sheet A is set equal to or lower than that at the surface treatment section 16 as described above.

Obviously, for performing appropriate surface treatment in the surface treatment section 16, it is preferable to prevent that the recording sheet A in the surface treatment section 16 receive the load change not only from the downstream section such as the cutting subsection 102 but also from the section upstream of the surface treatment section 16.

The conveying roller pair 82 immediately upstream the surface treatment section 16 is also provided with the one-way clutch, and the conveying speed of the recording sheet A at the conveying roller pair 82 is set equal to or lower than that at the surface treatment section 16. Therefore, when the recording sheet A is conveyed to the surface treatment section 16, even if the recording sheet A receives the load change in the direction in which the recording sheet A is pulled from the upstream side, the conveying roller pair 82 prevents this load change from being transmitted to the surface treatment section 16.

The conveying speed of the recording sheet A at the conveying roller pair 82 is equal to or lower than that at the surface treatment section 16. Thus, the conveying roller pair 82 does not cause the load change to the surface treatment section 16 in the direction in which the recording sheet A is pushed into the surface treatment section 16.

Contrary to this, considering the conveying speed, there is a possibility that the surface treatment section 16 pulls the recording sheet A, that is, the conveying roller pair 82 causes the load change to occur in the direction in which the recording sheet A is pulled out of the surface treatment section 16. However, since the conveying roller pair 82 includes the one-way clutch capable of idling only in the conveying direction, the surface treatment section 16 controls the conveying of the recording sheet A so as to pull the recording sheet A out of the conveying roller pair 82, so that the load change does not occur to the conveying in the surface treatment section 16.

After being subjected to the surface treatment in the surface treatment section 16, the recording sheet A is conveyed to the cutting/arranging section 18 by the conveying roller pairs 84 (84a, 84b) as described above.

The cutting/arranging section 18 includes the cutting subsection 102, an arranging subsection 104, and a discharging subsection 106.

The recording sheet A subjected to the surface treatment (application of glossiness) in the surface treatment section 16 is cut into a predetermined print size in the cutting subsection 102 of the cutting/arranging section 18, whereby a print P (hard copy) to be outputted as a product is obtained.

The cutting subsection 102 includes the first slitter unit 110, the second slitter unit 112, the guillotine cutter 114, and a registration roller pair 116.

Each of the first and second slitter units 110 and 112 is a known slitter unit using, for example, a rotary cutter or a circular cutter, for slitting the recording sheet A in the conveying direction.

The first and second slitter units 110 and 112 each include one slitter pair that can be adjusted in position in the width direction. The slitters of each of the first and second slitter units 110 and 112 are at the same position in the conveying direction while being arranged side by side in the width direction. The second slitter unit 112 is arranged downstream the first slitter unit 110.

Each of the first and second slitter units 110 and 112 moves its respective slitters in the width direction in accordance with the width information of the recording sheet A and positional information of an image on the recording sheet A (i.e., the positional information in the width direction), so that the recording sheet A being conveyed is slit in the conveying direction into a size in the width direction of a print to be produced.

The image recording apparatus 10 according to this embodiment records two images side by side in the width direction on the recording sheet A at a maximum (i.e., performs four-image imposition at a maximum), for example.

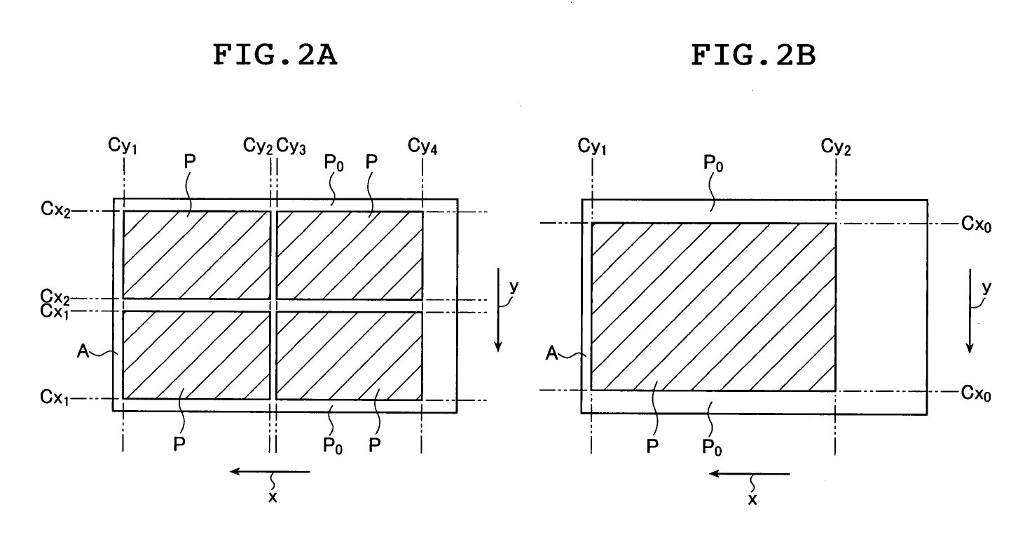

As shown in FIG. 2A, in the case of recording two images side by side in the width direction (indicated by an arrow “y”) (i.e., recording four images in total on the recording sheet A), the slitters of the first slitter unit 110 are arranged to correspond to one image in the width direction (e.g., an image on the left side when viewed from the upstream side to the downstream side in the conveying direction (indicated by an arrow “x”)), and the recording sheet A is slit along cutting (slit) lines Cx₁ while being conveyed, whereby the images on the left side in the width direction can have a print size in the width direction. The slitters of the second slitter unit 112 on the downstream side are arranged to correspond to the other image (i.e., an image on the right side when viewed from the upstream side to the downstream side in the conveying direction), and the recording sheet A is slit along cutting (slit) lines Cx₂ while being conveyed, whereby the images on the right side in the width direction can have a print size in the width direction.

In other words, first, the images on the left side when viewed from the upstream side to the downstream side in the conveying direction are slit by the first slitter unit 110 in the conveying direction, and then the images on the right side when viewed from the upstream side to the downstream side in the conveying direction are slit by the second slitter unit 112 in the conveying direction.

On the other hand, as shown in FIG. 2B, in the case of recording one image on the recording sheet A in the width direction, the slitters of the first slitter unit 110 are retracted from the conveying path of the recording sheet A, the slitters of the second slitter unit 112 are arranged to correspond to the image recorded on the recording sheet A, and the recording sheet A is slit along cutting (slit) lines Cx₀ while being conveyed, whereby the image can have a size of a corresponding print in the width direction.

The above-described guide means for guiding scraps Pₒ cut off when the recording sheet A is slit will be specifically explained.

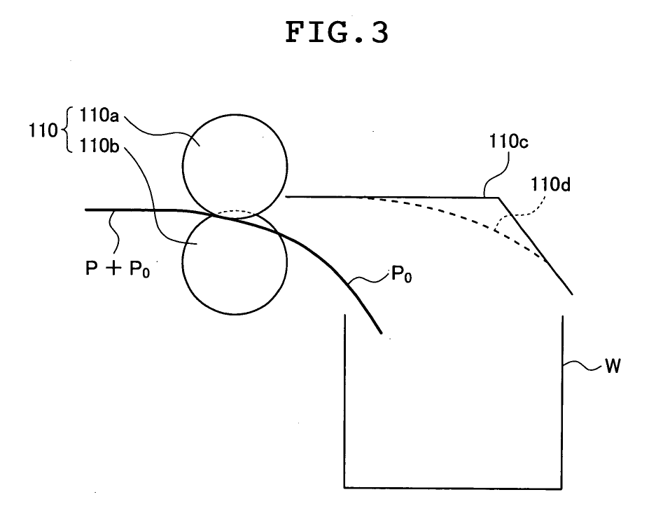

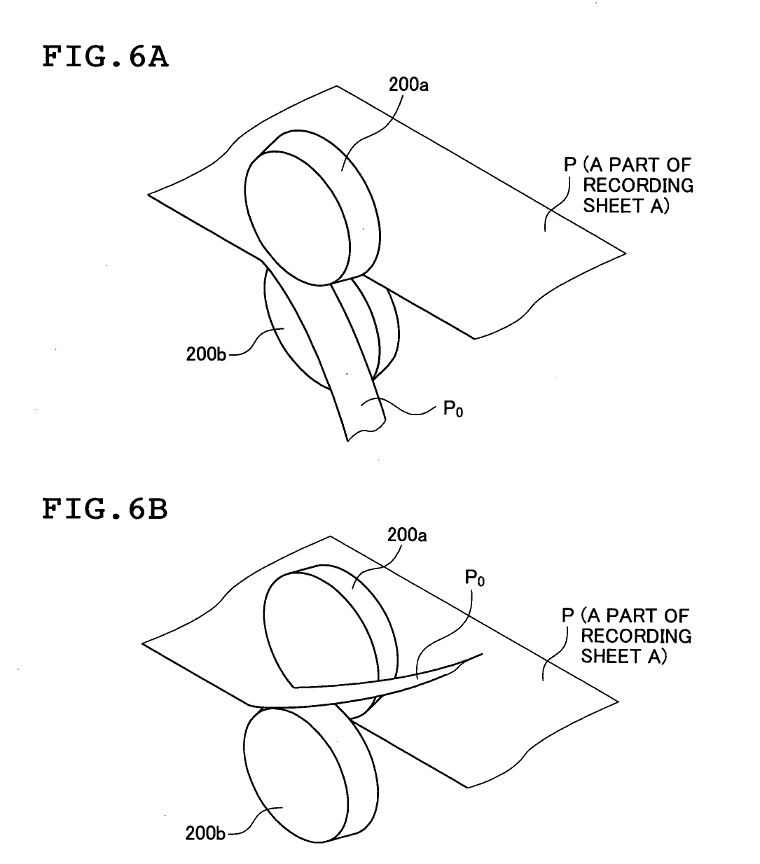

FIG. 3 shows the traveling direction of the tip part of the scrap Pₒ, the shape of a guide member 110c (110d) for guiding the tip part of the scrap Pₒ toward a collection unit (scrap collection container) W, and the attachment position of the guide member 110c. In FIG. 3, as shown in FIG. 6A, the positional relation between an upper blade 110a and a lower blade 110b of the slitter of the above-described first slitter unit 110 (or the second slitter unit 112, however, hereinafter, the first slitter unit 110 is shown as a representative) is such that the upper blade 110a is positioned outside the slitting position (that is, outside the image) when seen from the image side.

As shown in FIG. 3, the tip part of the scrap Pₒ travels downward immediately after having passed the first slitter unit 110, however, the traveling direction thereof is not always constant because of the difference in thickness, properties, and the like of the recording sheet A.

Thus, in the image recording apparatus 10 in this embodiment, the guide member 110c (110d) having a shape as illustrated in FIG. 3 is attached to the position as shown in FIG. 3.

That is, the guide member 110c (110d) extends approximately horizontally in the conveying direction of the recording sheet A from the position slightly downstream of the slit starting position of the recording sheet A slit by the first slitter unit 110, and bends at a position approximately above the front end part of the collection unit (scrap collection container) W so as to change the traveling direction of the tip part of the recording sheet A downward. The guide member 110c (110d) is attached such that the upstream end thereof is positioned slightly above the lower blade 110b.

The guide member 110d shown by a dotted line in FIG. 3 is another example of the guide member c, in which the bending part of the guide member c is formed to curve smoothly downward.

The shape of the guide member 110c (or the guide member 110d) is not limited to the above, and can be changed to any shape as long as the guide member is capable of smoothly guiding the tip part of the scrap Pₒ toward the receiving opening of the collection unit (scrap collection container) W.

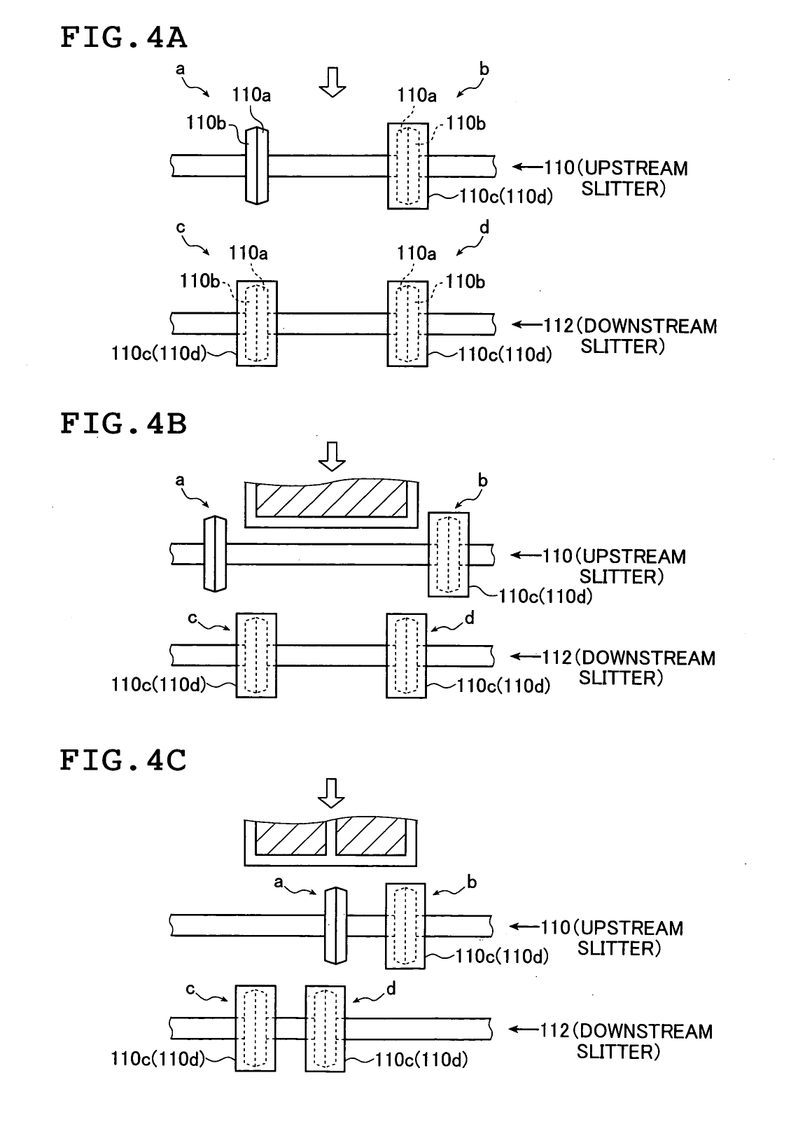

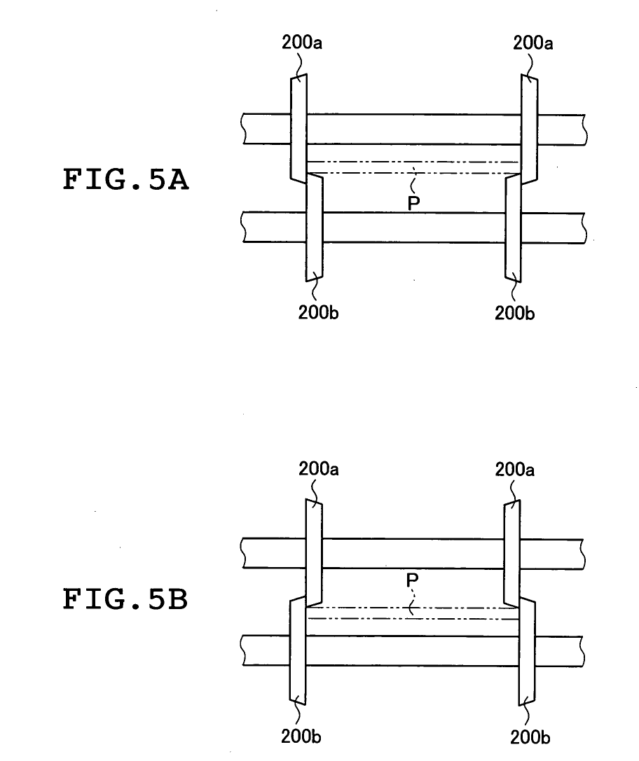

Specific examples of the arrangement position of the above guide member will be shown in FIGS. 4A to 4C. In FIGS. 4A to 4C, the positional relation between the upper blade 110a and the lower blade 110b is such that the upper blade 110a is positioned outside the slitting position (that is, outside the image) when seen from the image side.

More specifically, FIGS. 4A to 4C show the way to arrange the guide members 110c (or guide members 110d) for the slitters (a, b, c, d) of the two upstream and downstream slitter units (110, 112).

FIG. 4A is a view showing an example of the positions of the slitters in the width direction when the slitters are on standby. As shown in FIG. 4A, the guide member 110c (or 110d) is arranged for each of the slitters b, c, and d, which is a preferred arrangement example of the guide members 110c (or 110d) in the case of using the upstream and downstream slitter units 110 and 112 in a later described manner.

The function of the guide members 110c (or 11d) arranged in the above-described manner will be explained. In the case shown in FIG. 4B (i.e., in the case of recording one image on the recording sheet A in the width direction), the slitters (a, b) attached to the upstream slitter unit 110 are retracted from the area of the recording sheet A in the width direction, and the recording sheet A is slit by the slitters (c, d) attached to the downstream slitter unit 112. The scraps Pₒ separated by the slitting are smoothly guided by the guide members 110c (or 110d) to the receiving opening of the collection unit (scrap collection container) W to be collected into the collection unit W.

In the case shown in FIG. 4C (i.e., in the case of recording two images side by side in the width direction on the recording sheet A), the slitters (a, b) attached to the upstream slitter unit 110 are arranged so as to slit the image on the right side on the recording sheet A in the figure, and the slitters (c, d) attached to the downstream slitter unit 112 are arranged so as to slit the image on the left side.

In this case, only the margin at the right end of the recording sheet A is first cut off by the slitting with the slitters (a, b) of the upstream slitter unit 110, but the margin in the middle of the recording sheet A is still connected to the image on the left side. Then, the margin in the middle of the recording sheet A is finally cut off by the slitting with the slitters (c, d) of the downstream slitter unit 112, and is collected as the scrap Pₒ.

The slit mechanism of the image recording apparatus according to this embodiment operates in the above-described manner, so that it is possible to specify the slitters for which the guide members 110c (or 110d) are arranged by predetermining the usage pattern of the slitters, which results in reducing the number of the guide members 110c (110d) to be attached.

Unlike the above embodiment, the guide member 110c (110d) may be arranged not for specific slitters but for all the slitters. In this case, although the number of the guide members 110c (110d) to be attached is increased, there is no need to set the usage pattern of the slitters, for example, in the case where one image is recorded on the recording sheet A in the width direction as described above.

Explanation will be made of a method of deciding the angle of the upper and lower blades of the slitters of each of the slitter units 110 and 112.

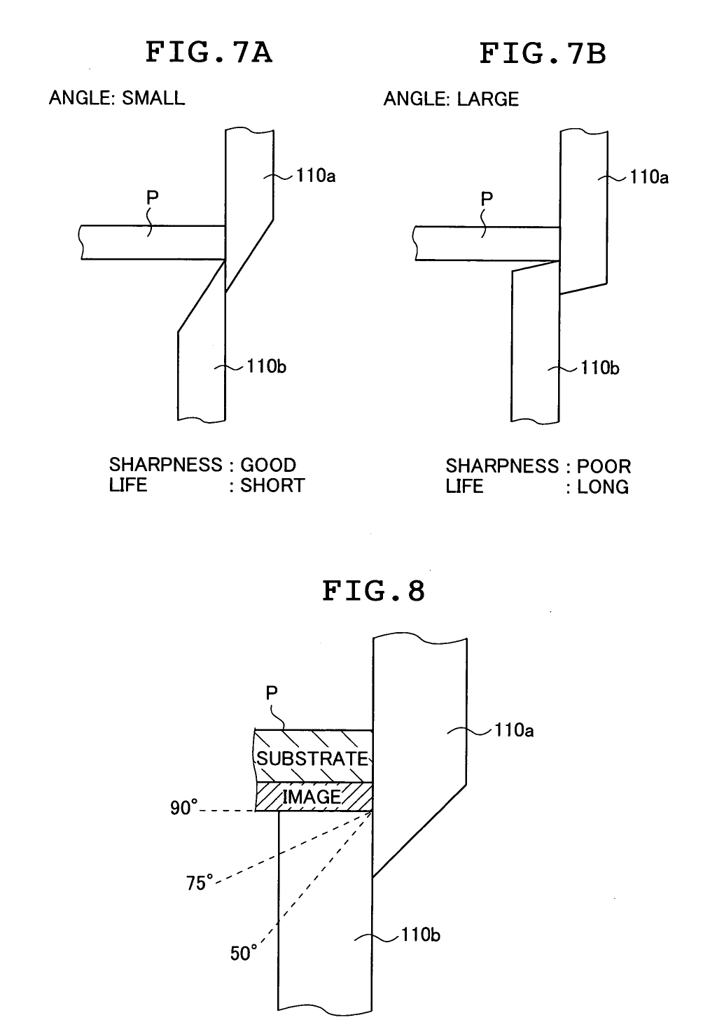

The following general concept will give an indication for deciding the angle of the blades. That is, when the angle of the blade is small, the sharpness of the blade is good but the life of the blade is short (see FIG. 7A), whereas when the angle of the blade is large, the sharpness of the blade is poor but the life of the blade is long (see FIG. 7B).

The properties of an image formed on the print obtained by slitting greatly affect the sharpness evaluation of the blade, and consideration should be given to the fact that an image on the print produced by the image recording apparatus of the electrophotographic system or the thermal print system used in this embodiment is easily damaged. This damage is caused due to the difference of the peripheral speed of the blade in the thickness direction, particularly in the case of the blade with small angle.

Considering the above conditions, for example, in the case of the print produced by the image recording apparatus of the electrophotographic system or the thermal print system, when the image is formed on the lower surface of the recording sheet A as shown in FIG. 8, the angle of the lower blade is preferably 75°. When the angle of the lower blade is 90°, there is less possibility to damage the image, but a problem with the sharpness of the blade remains unsolved. When the angle of the lower blade is 50°, there are problems with the damage to the image and the life of the blade. Thus, the angle of the lower blade is set at appropriately 75° as the most preferable angle between 50° and 90°.

The angle of the upper blade corresponding to the lower blade is determined in combination with the angle of the lower blade, and the angles of the lower and upper blades are set in an appropriate range so as to obtain excellent properties.

As described above, properties of an image formed on the print obtained by slitting greatly affect the sharpness evaluation of the blade, so that it is to be understood that the above-described angle of the lower blade is just an example.

Next, the guillotine cutter 114 arranged downstream of the slitter unit 112 will be explained.

The guillotine cutter 114 is a known guillotine cutter for cutting the recording sheet A in the width direction.

The registration roller pair 116 is a conveying roller pair for stopping conveying of the recording sheet A at the position at which the recording sheet A is cut by the guillotine cutter 114 according to the positional information of the image on the recording sheet A (i.e., positional information in the conveying direction). In other words, the registration roller pair 116 is for determining the cutting position of the recording sheet A in its conveying direction.

For example, in the case of recording two images side by side in the conveying direction as shown in FIG. 2A, the registration roller pair 116 first stops conveying of the recording sheet A when a cutting (cut) line Cy₁ at the forward ends of the images on the forward side of the sheet has come to the cutting position of the guillotine cutter 114. Then, the guillotine cutter 114 is activated so as to cut the recording sheet A along the cutting (cut) line Cy₁.

After the cutting, the registration roller pair 116 resumes the conveying of the recording sheet A, and stops the conveying of the recording sheet A when the cutting (cut) line Cy₂ at the rear ends of the forward images has come to the cutting position of the guillotine cutter 114. Then, similarly to the above, the guillotine cutter 114 is activated so as to cut the recording sheet A along the cutting (cut) line Cy₂. In the cutting subsection 102, the recording sheet A has already been slit along the cutting (slit) lines Cx₁ and Cx₂ by the first and second slitter units 110 and 112, so that two prints P on the forward side are cut out by cutting the recording sheet by the guillotine cutter 114 twice.

Similarly to the above, after the cutting of the recording sheet along the cutting (cut) line Cy₂, the registration roller pair 116 resumes the conveying of the recording sheet A, and stops the conveying of the recording sheet A when the cutting (cut) line Cy₃ at the forward ends of the rear images in the conveying direction has come to the cutting position of the guillotine cutter 114. Then, the guillotine cutter 114 is activated so as to cut the recording sheet A along the cutting (cut) line Cy₃. Thereafter, the registration roller pair 116 resumes the conveying of the recording sheet A, and stops the conveying of the recording sheet A when the cutting (cut) line Cy₄ at the rear ends of the rear images has come to the cutting position of the guillotine cutter 114. Then, the guillotine cutter 114 is activated so as to cut the recording sheet A along the cutting (cut) line Cy₄.

By the slitting of the recording sheet A along the cutting (slit) lines Cx₁ and Cx₂, and the cutting of the recording sheet A along the cutting (cut) lines Cy₃ and Cy₄, two prints P on the rear side are cut out as in the case of the two prints P on the forward side. Consequently, four prints P each of which corresponds to a print size and bears one of four images recorded on the recording sheet A are cut out.

On the other hand, in the case of recording one image in the conveying direction as shown in FIG. 2B, the registration roller pair 116 stops conveying of the recording sheet A when a cutting (cut) line Cy₁, at the forward end of the image has come to the cutting position of the guillotine cutter 114. Then, the guillotine cutter 114 is activated so as to cut the recording sheet A along the cutting (cut) line Cy₁.

After the cutting, the registration roller pair 116 resumes the conveying of the recording sheet A, and stops the conveying of the recording sheet A when the cutting (cut) line Cy₂ at the rear end of the image has come to the cutting position of the guillotine cutter 114. Then, in a similar manner, the guillotine cutter 114 is activated so as to cut the recording sheet A along the cutting (cut) line Cy₂. As described above, in the cutting subsection 102, the recording sheet A has already been slit along the cutting (slit) lines Cx₀ by the second slitter unit 112, so one print corresponding to a print size and bearing the image recorded on the recording sheet A is cut out as a result of the cutting operation with the guillotine cutter 114.

Each print P which was cut out from the recording sheet A by the slitting and cutting in the cutting subsection 102 is then conveyed to the arranging subsection 104, and is further conveyed from the arranging subsection 104 to the discharging subsection 106.

The arranging subsection 104 is for discharging the prints P cut out in the cutting subsection 102 to the discharging subsection 106. In the case of recording two images side by side in the width direction on the recording sheet A, the arranging subsection 104 unifies two lines of prints P that have been obtained in the width direction through slitting in the cutting subsection 102 into one line, and discharges the unified prints P to the discharging subsection 106. In the illustrated example, the arranging subsection 104 includes a conveying roller pair 120, conveying roller pairs 122, 124, and 132, a discharging roller pair 126, and a line unifying roller pair 130.

The discharging subsection 106 is a belt conveyer including two rollers 140 and an endless belt 142 stretched across the rollers 140.

The conveying roller pair 120 of the arranging subsection 104 includes two roller pairs 120a and 120b arranged side by side in the width direction. The roller pairs 120a and 120b are driven independently.

In the case where two images have been recorded side by side in the width direction, the roller pair 120a serves to convey each print P obtained through slitting with the first slitter unit 110 along the cutting (slit) lines Cx₁, and the roller pair 120b serves to convey each print P obtained through slitting with the second slitter unit 112 along the cutting (slit) lines Cx₂.

The conveying path in the arranging subsection 104 is branched at the position downstream of the conveying roller pair 120, and the arranging subsection 104 includes a lower first conveying path 134 including the conveying roller pairs 122 and 124, and an upper second conveying path 136 including the line unifying roller pair 130 and the conveying roller pair 132. The line unifying roller pair 130 of the second conveying path 136 is a conveying roller pair movable in the width direction.

The conveying path on which the roller pair 120a is provided corresponds to the first conveying path 134, and the conveying path on which the roller pair 120b is provided corresponds to the second conveying path 136. A not shown guide member which acts on the conveying path on which the roller pair 120a is provided and optionally the conveying path on which the roller pair 120b is provided to guide the prints P to the first conveying path 134 is disposed at the position at which the above conveying path branches out into the first and second conveying paths.

In addition, the first conveying path 134 and the second conveying path 136 join at the position downstream of the conveying roller pairs 124 and 132 by a not shown guide member and the like to form the convey path on which the discharging roller pair 126 is provided.

As shown in FIG. 2A, in the case where two images have been recorded on the recording sheet A side by side in the width direction, the guide member acts only on the conveying path on which the roller pair 120a of the conveying roller pair 120 is provided.

When the two lines of the cut out prints P disposed in the width direction are conveyed to the arranging subsection 104, the print P cut out by the first slitter unit 110 is conveyed to the first conveying path 134 by the roller pair 120a and the guide member, and the print cut out by the second slitter unit 112 is conveyed to the second conveying path 136 by the roller pair 120b.

The print P conveyed along the first conveying path 134 by the roller pairs 122 and 124 is sent to the discharging roller pair 126 to be discharged to the discharging subsection 106.

On the other hand, when the print P conveyed along the second conveying path 136 is nipped by the line unifying roller pair 130, the conveying of the print P is stopped (similarly, the roller pair 120b is also stopped). Next, after the conveying roller pair 120 releases the print P if required, the line unifying roller pair 130 moves in the width direction, so that the print P is moved to the position corresponding to the roller pair 120a in the width direction. Thereafter, the line unifying roller pair 130 and the conveying roller pair 132 start conveying of the print P in synchronization with the timing of supplying of the print P conveyed along the first conveying path 134 to the conveying roller path 126 so that each set of the prints P disposed side by side are sequentially conveyed to the conveying roller path 126. Next, the discharging roller pair 126 discharges the print P to the discharging subsection 106.

In the example shown in FIG. 2A, two prints P have been formed side by side also in the conveying direction.

In this case, when the preceding print P has passed through the line unifying roller pair 130, the line unifying roller pair 130 moves backward in the width direction to return to the original position. Then, the rear print P in the conveying direction is conveyed to the second conveying path 136 by the roller pair 120b. Similarly to the above, when the rear print P sent to the second conveying path 136 is nipped between the line unifying roller pair 130, the conveying of the rear print P is stopped and the conveying roller pair 120 releases the rear print P if required. Next, the line unifying roller pair 130 moves in the width direction, thereby moving the rear print P to the position in the width direction corresponding to the roller pair 120a. Then, the rear print P is conveyed by the line unifying roller pair 130 and the conveying roller pair 132, and then discharged to the discharging subsection 106 by the conveying roller pair 126.

Whereby, two or more lines of the prints P arranged in the width direction are unified into one line and then discharged to the discharging subsection 106.

Whereas, in the case where one image has been recorded on the recording sheet A in the width direction as shown in FIG. 2B, the guide member acts on the conveying path on which the roller pair 120a is provided and the conveying path on which the 120b is provided.

When the cut out print P is conveyed to the arranging subsection 104, the conveying roller pair 120 whose roller pairs 120a and 120b are driven in synchronization with each other, and the guide member convey the cut out print P to the first conveying path 134, where the print P is conveyed along the first conveying path 134 by the roller pairs 122 and 124 to the discharging roller pair 126 and is then discharged to the discharging subsection 106 by the discharging roller pair 126.

The discharging subsection 106 receives the prints P conveyed by and discharged/dropped from the discharging roller pair 126 and stacks the prints P on the belt conveyer. When it is confirmed based on the sort information and the like that the prints of one order have been stacked thereon, the discharging subsection 106 conveys the stack of the prints P by a predetermined distance set in accordance with the print size (i.e., the maximum print length in the prints of one order) and the like, and stops the conveying. Then, the discharging subsection 106 receives the prints P of the next order.

The above embodiment shows one example of the present invention, and the present invention is not limited thereto. It should be understood that various improvements and modifications are possible without departing from the scope of the present invention.

For example, in the above embodiment, the cutter is arranged downstream the slitter, however, the slitter may be arranged downstream the cutter.

What is claimed is:

1. A slit mechanism of an image recording apparatus used to obtain a print of a predetermined print size by cutting off and removing margins on a periphery of each of one or more images that were recorded on an image recording medium side by side along a width direction, comprising:
slitter units for slitting the margins of the recording medium in a conveying direction of the recording medium in accordance with the predetermined print size by utilizing a conveying force of the recording medium, the slitter units each including a pair of slitters, being disposed upstream and/or downstream in the conveying direction of a cutter that cuts the margins of the recording medium in the width direction orthogonal to the conveying direction in accordance with the predetermined print size while conveying of the recording medium is stopped, and being arranged along the conveying direction of the recording medium;
guide means for guiding a scrap that is cut off when the recording medium is slit by at least one slitter of the pair of slitters; and
slitter moving means for moving the at least one slitter of the pair of slitters and the guide means in synchronization in the width direction of the recording medium between a slitting position at which the recording medium is slit into a predetermined width corresponding to the predetermined print size and a position outside the recording medium in the width direction,
wherein the guide means is disposed only at a position where the scrap is cut off by slitting the margins of the recording medium with the at least one slitter of the pair of slitters.

2. The slit mechanism of the image recording apparatus according to claim 1, wherein:
the pair of slitters includes two upper blades and two lower blades;
the lower blades are positioned inside the upper blades while being engaged with the upper blades from inside, respectively, and slit the recording medium; and
an upstream end of the guide means is arranged above at least one of the lower blades of the pair of slitters, and the guide means is disposed above the at least one of the lower blades from a position upstream of a slit starting position at which the recording medium is slit by the at least one slitter of the pair of slitters toward downstream side and is bent in a vicinity of a position at which the recording medium passes above the at least one of the lower blades so as to guide the scrap downward.

3. The slit mechanism of the image recording apparatus according to claim 1, wherein the recording medium is slit by one of the slitter units located on a most downstream side in the conveying direction in a case where one image is recorded on the recording medium along the width direction.

4. The slit mechanism of the image recording apparatus according to claim 1, wherein the recording medium is slit for one image by a first slitter unit of the slitter units, and is slit for a remaining image by a second slitter unit of the slitter units that is arranged downstream of the first slitter unit in the conveying direction, in a case where multiple images are recorded on the recording medium side by side along the width direction.
